(19) United States
(12) Patent Application Publication
(10) Pub. No.: US 2020/0021498 A1
(43) Pub. Date: Jan. 16, 2020

(54) FIRST CONTROL APPARATUS, APPARATUS, METHOD, PROGRAM, RECORDING MEDIUM, AND SYSTEM

(71) Applicant: NEC CORPORATION, Tokyo (JP)

(72) Inventors: Akihito KOHIGA, Tokyo (JP); Shinya ISHIDA, Tokyo (JP); Takanori IWAI, Tokyo (JP); Hiroya KANEKO, Tokyo (JP)

(73) Assignee: NEC CORPORATION, Tokyo (JP)

(21) Appl. No.: 16/490,781

(22) PCT Filed: Mar. 10, 2017
(86) PCT No.: PCT/JP2017/009639

§ 371 Date: Sep. 3, 2019

(51) Int. Cl. H04L 12/24; H04L 12/751

(52) U.S. Cl. CPC H04L 41/147; H04L 41/5009; G06F 2009/4557; H04L 41/5019; H04L 45/02

(57) ABSTRACT

To provide a control apparatus capable of maintaining quality related to service while efficiently using resource for providing the service via a communication network. A communication resource controller 100 includes: a reception processing section 133 configured to receive time information related to time required for control of resource for providing service via a communication network 20, the control being performed by one or more other control apparatuses (a network function virtualization controller 300 and an application controller 400); and a prediction section 135 configured to predict quality related to the service over a period based on the time information.

### BACKGROUND

### Technical Field

The present invention relates to a first control apparatus, an apparatus, a method, a program, a recording medium, and a system that are related to provision of service via a communication network.

### Background Art

For example, an apparatus connected to a communication network such as Mobile Edge Computing (MEC), Internet of Things (IoT) Service Enabler, or IoT-GW monitors quality related to service provided to user equipment (UE) via the communication network. In addition, when it is determined that it is impossible to maintain the quality related to the service, the apparatus notifies Management and Network Orchestration (MANO) or the like, and requests expansion of resource of the communication network such as addition of calculation resource of a virtual network function, for example. In response to the request, MANO is capable of assuring the quality and the service, reducing load on the whole communication network, and the like by controlling the resource of the communication network such as adding calculation resource of the virtual network function to the communication network.

For example, PTL 1 describes a system including a packet transfer apparatus existing in a wide area network, a virtual machine and virtual packet transfer apparatus that are included in a data center, and a gateway. PTL 1 discloses that, when a virtual machine to which load is concentrated is detected, the system copies the virtual machine to another data center, creates a tunnel between the virtual machines, distributes the load to the plurality of virtual machines, and carries out a process.

### CITATION LIST

### Patent Literature

### SUMMARY

### Technical Problem

However, according to the technology disclosed in the PTL 1, the process of distributing the load is carried out regardless of change in a communication network environment such as change in a usage situation of the resource for providing the service. Therefore, the technology disclosed in PTL 1 has a possibility of violating the quality related to the service before the process of distributing the load is completed.

In particular, the problem may appear when minimum resource is added as late as possible in view of efficient use of the resource.

An example object of the present invention is to provide the first control apparatus, the apparatus, the method, the program, the recording medium, and the system that are capable of maintaining quality related to service while efficiently using resource for providing the service via a communication network.

### Solution to Problem

A first control apparatus according to the present invention includes: a reception processing section configured to receive time information related to time required for control of resource for providing service via a communication network, the control being performed by one or more other control apparatuses; and a prediction section configured to predict quality related to the service over a period based on the time information.

An apparatus according to the present invention includes: an obtaining section configured to obtain time information related to time required for control of resource for providing service via a communication network; and a transmission processing section configured to transmit the time information to a first control apparatus that predicts quality related to the service.

A first method according to the present invention includes: receiving time information related to time required for control of resource for providing service via a communication network, the control being performed by one or more other control apparatuses; and predicting quality related to the service over a period based on the time information.

A second method according to the present invention includes: obtaining time information related to time required for control of resource for providing service via a communication network; and transmitting the time information to a first control apparatus that predicts quality related to the service.

A first program according to the present invention is a program that causes a processor to: receive time information related to time required for control of resource for providing service via a communication network, the control being performed by one or more other control apparatuses; and predict quality related to the service over a period based on the time information.

A second program according to the present invention is a program that causes a processor to: obtain time information related to time required for control of resource for providing service via a communication network; and transmit the time information to a first control apparatus that predicts quality related to the service.

A first recording medium according to the present invention is a computer-readable non-transitory recording medium having recorded thereon a program that causes a processor to: receive time information related to time required for control of resource for providing service via a communication network, the control being performed by one or more other control apparatuses; and predict quality related to the service over a period based on the time information.

A second recording medium according to the present invention is a computer-readable non-transitory recording medium having recorded thereon a program that causes a processor to: obtain time information related to time required for control of resource for providing service via a communication network; and transmit the time information to a first control apparatus that predicts quality related to the service.

A system according to the present invention includes: a first control apparatus including a reception processing section configured to receive time information related to time required for control of resource for providing service via a communication network, the control being performed by one or more other control apparatuses, and a prediction section configured to predict quality related to the service over a period based on the time information; and an apparatus including an obtaining section configured to obtain the time information related to the time required for the control of the resource for providing the service via the communication network, and a transmission processing section configured to transmit the time information to the first control apparatus that predicts the quality related to the service.

### Advantageous Effects of Invention

According to the present invention, it will be possible to maintain quality related to service while efficiently using resource for providing the service via a communication network. Note that the present disclosure may exert other advantageous effects instead of the above advantageous effect or together with the above advantageous effect.

### BRIEF DESCRIPTION OF THE DRAWINGS

FIG. 1 is a schematic diagram of a configuration of an IoT service platform 1000;

FIG. 2 is an explanatory diagram schematically illustrating an example in which quality related to service is not maintained due to increase in traffic;

FIG. 3 is an explanatory diagram illustrating an example of a schematic configuration of the system 1 according to an example embodiment of the present invention;

FIG. 4 is a block diagram illustrating an example of a schematic configuration of a communication resource controller 100;

FIG. 5 is a block diagram illustrating an example of a schematic configuration of a management apparatus 200 according to a first example embodiment;

FIG. 6 is a block diagram illustrating an example of a schematic configuration of a network function virtualization controller 300;

FIG. 7 is a block diagram illustrating an example of a schematic configuration of an application controller 400;

FIG. 8 is a diagram illustrating an example of predicted time response of throughput;

FIG. 9 is a flowchart for describing an example of a schematic flow of a process of updating a period based on time information according to the first example embodiment;

FIG. 10 is an explanatory diagram of an example of a schematic flow of a process of updating time information;

FIG. 11 is an explanatory diagram of respective examples of time information 1101 before update and time information 1103 after the update;

FIG. 12 is a flowchart for describing an example of a schematic flow of a process of maintaining quality related to service according to the first example embodiment;

FIG. 13 is an explanatory diagram of an example of a schematic flow of a process of requesting control of resource;

FIG. 14 is a diagram illustrating an example (dotted line) of predicted time response of throughput and an example (solid line) of time response of throughput when control of resource is executed;

FIG. 15 is a block diagram illustrating an example of a schematic configuration of a first control apparatus 500 according to a second example embodiment; and

FIG. 16 is a block diagram illustrating an example of a schematic configuration of an apparatus 600 according to the second example embodiment.

### DESCRIPTION OF THE EXAMPLE EMBODIMENTS

Example embodiments of the present invention will be described in detail below with reference to the accompanying drawings. Note that, in the present Specification and drawings, elements to which similar descriptions are applicable are denoted by the same reference signs, whereby overlapping descriptions may be omitted.

Descriptions will be given in the following order.
1. Related Technology
2. Overview of Example Embodiment of Present Invention
3. Configuration of System
4. First Example Embodiment
4.1. Configuration of Communication Resource Controller
4.2. Configuration of Management Apparatus
4.3. Configuration of Network Function Virtualization Controller
4.4. Configuration of Application Controller
4.5. Technical Feature
5. Second Example Embodiment
5.1. Configuration of First Control Apparatus
5.2. Configuration of Apparatus
5.3. Technical Feature
6. Other Example Embodiments

### 1. Related Technology

An IoT service platform will be described as a technology related to an example embodiment of the present invention.

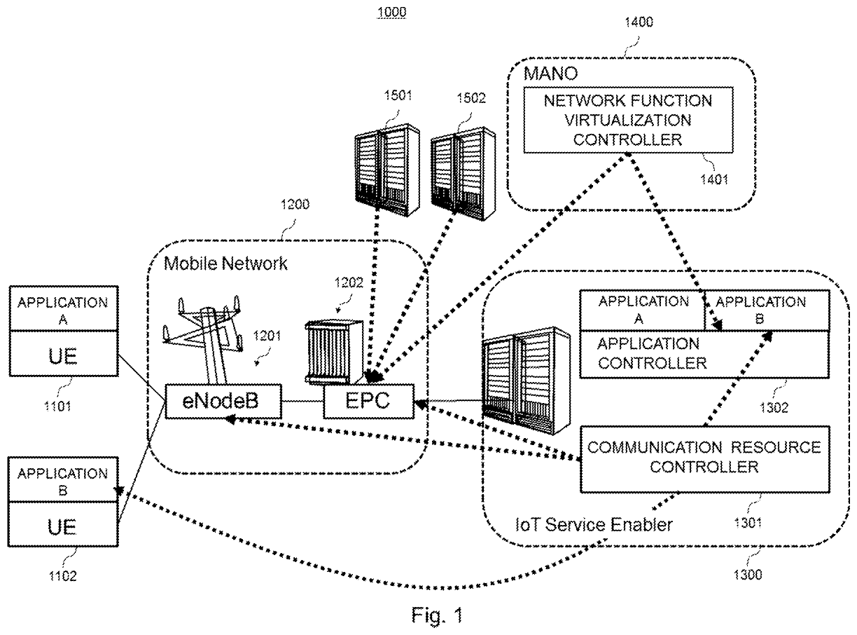

FIG. 1 is a schematic diagram of a configuration of an IoT service platform 1000. For example, as illustrated in FIG. 1, the IoT service platform 1000 includes user equipment (UE) 1101 and user equipment (UE) 1102 such as mobile phones, a mobile network 1200 that the UE 1101 and the UE 1102 access, IoT Service Enabler 1300, Management and Network Orchestration (MANO) 1400, and a plurality of (such as two) data centers 1501 and 1502. IoT Service Enabler 1300, Management and Network Orchestration (MANO) 1400, the plurality of data centers 1501 and 1502 are connected to the mobile network 1200

For example, in the UE 1101, a program for executing an application A for providing service via the mobile network 1200 is installed. In addition, for example, in the user equipment (UE) 1102, a program for executing an application B for providing service via the mobile network 1200 is installed.

For example, the mobile network 1200 includes an eNodeB 1201 and Evolved Packet Core (EPC) 1220. A part of network functions of the mobile network 1200 is virtualized.

IoT Service Enabler 1300 includes a communication resource controller 1301 and an application controller 1302. The communication resource controller 1301 analyzes characteristics (context) of the mobile network 1200 and controls communication resource. The application controller 1302 controls calculation resource related to the applications A and B. The communication resource controller 1301 may be referred to as a context-aware controller (CAC). In addition, the application controller 1302 may be referred to as an edge computing orchestrator (ECO). IoT Service Enabler 1300 itself or each of the communication resource controller 1301 and the application controller 1302 may be Service Capability Exposure Function (SCEF) specified in 3GPP. In addition, the application controller 1302 may be Application Server specified in 3GPP.

MANO 1400 includes a network function virtualization controller 1401 that controls virtual network functions of the mobile network 1200. The network function virtualization controller 1401 may be referred to as Network Functions Virtualization Orchestrator (NVFO).

The IoT service platform 1000 configured as described above controls resource of the mobile network 1200 as described below.

First, for example, the communication resource controller 1301 analyzes characteristics (context) such as throughput in a communication channel (mobile network 1200) used for the application B, and controls communication resource of the mobile network 1200 in accordance with a result of the analysis. In addition, the application controller 1302 performs control related to calculation resource of the application B such as deciding a base point (such as the data center 1501 or 1502) to which the calculation resource of the application B will be allocated. In addition, the network function virtualization controller 1401 controls calculation resource of a virtual network function of the mobile network 1200 (such as addition of calculation resource).

### 2. Overview of Example Embodiment of Present Invention

First, an overview of an example embodiment of the present invention will be described.

### (1) Technical Problem

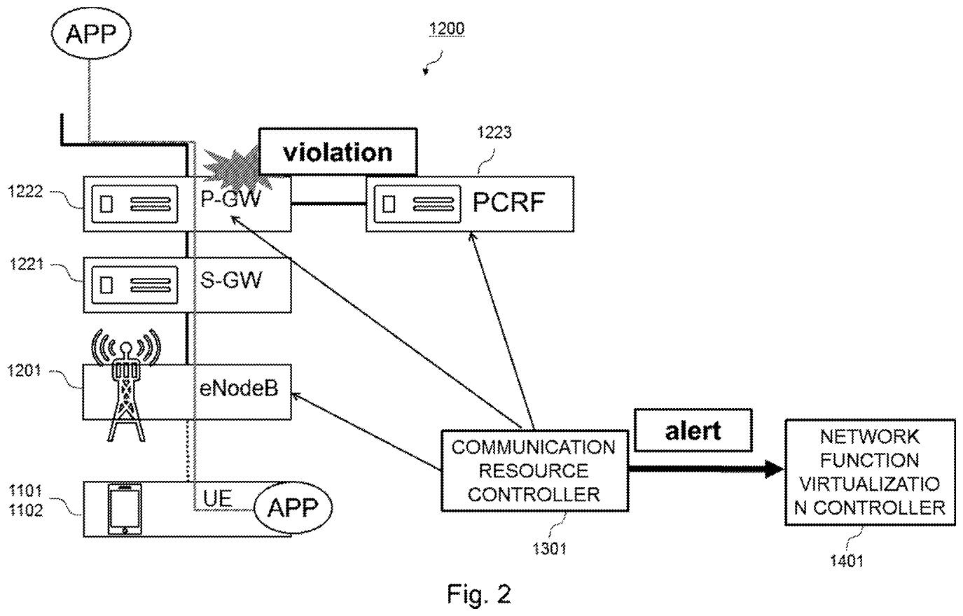

With regard to a system that provides service to UE via a communication network such as the above-described IoT service platform, a communication network environment changes like change in a resource usage situation. Depending on such change in the environment, time required for adding resource is changed. As a result, for example, sometimes it is impossible to maintain quality related to service as illustrated in FIG. 2.

FIG. 2 is an explanatory diagram schematically illustrating an example in which quality related to service is not maintained due to increase in traffic.

As illustrated in FIG. 2, for example, the communication resource controller 1301 controls communication resource of respective elements constituting the mobile network 1200 such as the eNodeB 1201, Serving Gateway (S-GW) 1221, Packet Date Network Gateway (P-GW) 1222, and Policy and Charge Rules Function (PCRF) 1223. Here, when it is determined that control of the communication resource is not enough to maintain the quality related to the service, it is necessary for the communication resource controller 1301 to notify the network function virtualization controller 1401 of alert and request addition of calculation resource, for example. In particular, it is desired to request the addition as late as possible in view of efficient use of the resource.

However, as described above, the time required for the addition of the calculation resource may vary depending on the communication network environment. Therefore, when the time required for the addition of the calculation resource is longer than time predicted by the communication resource controller 1301, there is a problem of violating the quality related to the service before the addition of the calculation resource is completed.

An example object of the example embodiments of the present invention is to certainly maintain quality related to service while efficiently using resource for providing the service via the communication network.

### (2) Technical Feature

For example, according to an example embodiment of the present invention, a first control apparatus receives time information related to time required for control of resource for providing service via a communication network, and predicts quality related to the service over a period based on the time information. The control is performed by one or more other control apparatuses.

In addition, for example, according to an example embodiment of the present invention, a second control apparatus or a management apparatus obtains the time information related to the time required for the control of the resource for providing the service via the communication network, and transmits the time information to the first control apparatus that predicts the quality related to the service.

According to the configurations, it will be possible to certainly maintain quality related to service while efficiently using resource for providing the service via the communication network, for example.

Note that the above-described technical features are a specific example of the example embodiment according to the present invention. The example embodiment of the present invention is not limited to the above-described technical features.

### 3. Configuration of System

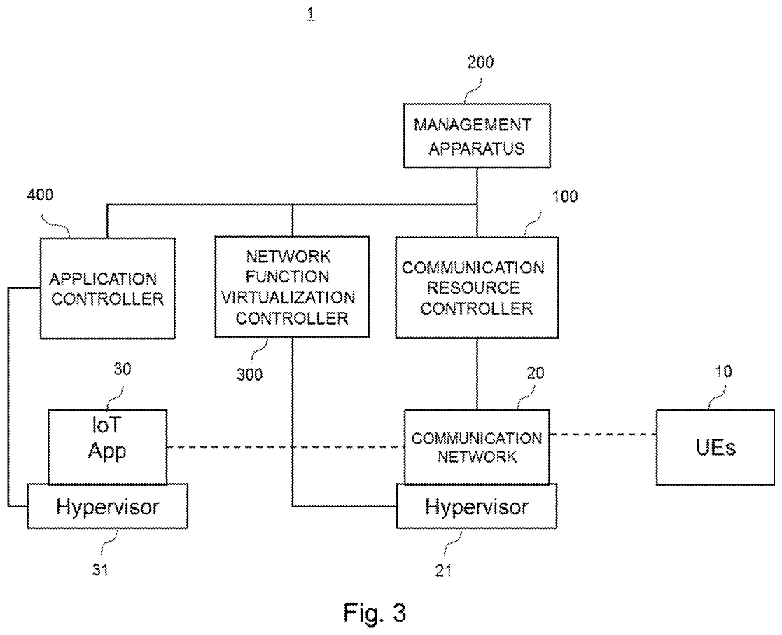

With reference to FIG. 3, an example of a configuration of the system 1 according to the example embodiment of the present invention will be described. FIG. 3 is an explanatory diagram illustrating an example of a schematic configuration of the system 1 according to the example embodiment of the present invention. With reference to FIG. 3, the system 1 is a system that performs control and management related to service that an IoT application 30 provides to UE 10 via a communication network 20. The system 1 includes a communication resource controller 100, a management apparatus 200, a network function virtualization controller 300, and an application controller 400. Here, a part of functions of the communication network 20 is virtualized by a hypervisor 21. In addition, some or all of functions of the IoT application 30 are virtualized by a hypervisor 31.

### (1) Communication Resource Controller 100

The communication resource controller 100 analyzes characteristics (context) of service provided via the communication network 20, and performs control related to communication resource in accordance with a result of the analysis.

### (2) Management Apparatus 200

The management apparatus 200 communicates with the communication resource controller 100, the network function virtualization controller 300, and the application controller 400.

### (3) Network Function Virtualization Controller 300

For example, the network function virtualization controller 300 accesses the hypervisor 21 and performs control related to network function virtualization of the communication network 20.

### (4) Application Controller 400

For example, the application controller 400 accesses the hypervisor 31 and performs control related to the IoT application 30.

### (5) Conclusion

The communication resource controller 100, the network function virtualization controller 300, and the application controller 400 are control apparatuses that control resource for providing service via the communication network 20.

### 4. First Example Embodiment

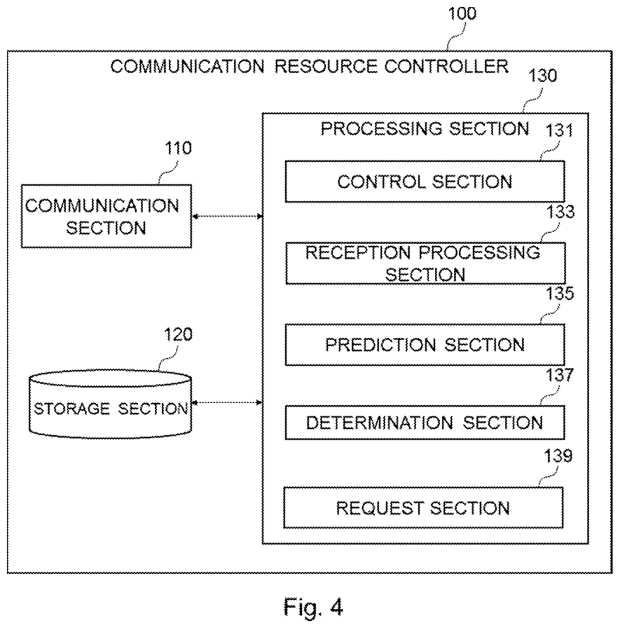

Next, the first example embodiment of the present invention will be described with reference to FIG. 4 to FIG. 14.

### <4.1. Configuration of Communication Resource Controller>

Next, with reference to FIG. 4, an example of a configuration of the communication resource controller 100 will be described. FIG. 4 is a block diagram illustrating an example of a schematic configuration of the communication resource controller 100. With reference to FIG. 4, the communication resource controller 100 includes a communication section 110, a storage section 120, and a processing section 130.

### (1) Communication Section 110

The communication section 110 receives respective signals from the communication network 20 and the management apparatus 200, and transmits respective signals to the communication network 20, the management apparatus 200, and other control apparatuses (such as the network function virtualization controller 300 and the application controller 400, for example).

### (2) Storage Section 120

The storage section 120 stores a program and parameters for operation of the communication resource controller 100 as well as various data temporarily or permanently. The program includes one or more instructions for operation of the communication resource controller 100.

### (3) Processing Section 130

The processing section 130 provides various functions of the communication resource controller 100. The processing section 130 includes a control section 131, a reception processing section 133, a prediction section 135, a determination section 137, and a request section 139.

For example, the processing section 130 (the control section 131) performs control (first control) of resource for providing service via the communication network. For example, the first control may be control of allocation of radio resource, more specifically, control of allocation of radio frequency bands.

Note that the processing section 130 may further include another constituent element than these constituent elements. That is, the processing section 130 may perform operations other than the operations of these constituent elements. Specific operations of the control section 131, the reception processing section 133, the prediction section 135, the determination section 137, and the request section 139 will be described later in detail.

### (4) Implementation Example

The communication section 110 may be implemented with a transmission circuit and a reception circuit, a network adapter and/or a network interface card, etc. The storage section 120 may be implemented with memory (for example, non-volatile memory and/or volatile memory), and/or a hard disk, etc. The control section 131, the reception processing section 133, the prediction section 135, the determination section 137, and the request section 139 may be implemented by the same processor or may be implemented by respective different processors. The memory (the storage section 120) may be included in such a processor (chip).

The communication resource controller 100 may include memory that stores programs (instructions) and one or more processors that are capable of executing the programs (instructions). The one or more processors may execute the programs and perform operations of the processing section 130 (operations of the control section 131, the reception processing section 133, the prediction section 135, the determination section 137, and the request section 139). The programs may be programs for causing the processors to execute the operations of the processing section 130 (operations of the control section 131, the reception processing section 133, the prediction section 135, the determination section 137, and the request section 139).

### <4.2. Configuration of Management Apparatus>

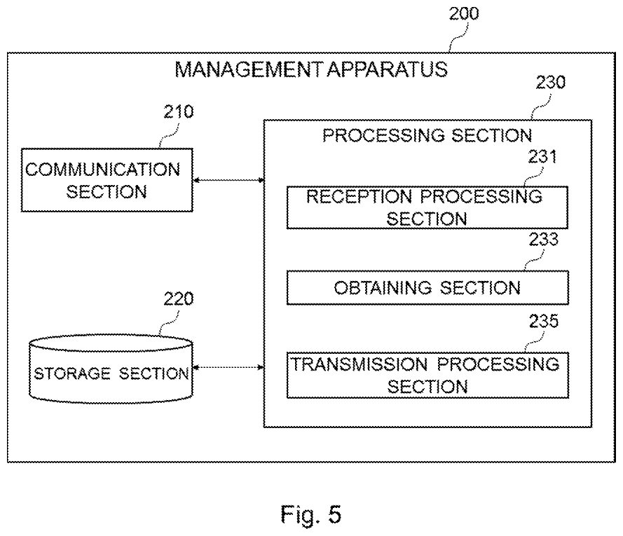

Next, with reference to FIG. 5, an example of a configuration of the management apparatus 200 according to the first example embodiment will be described. FIG. 5 is a block diagram illustrating an example of a schematic configuration of the management apparatus 200 according to a first example embodiment. With reference to FIG. 5, the management apparatus 200 includes the communication section 210, the storage section 220, and the processing section 230.

### (1) Communication Section 210

The communication section 210 receives respective signals from the communication resource controller 100, the network function virtualization controller 300, and the application controller 400, and transmits respective signals to the communication resource controller 100, the network function virtualization controller 300, and the application controller 400.

### (2) Storage Section 220

The storage section 220 stores a program and parameters for operation of the management apparatus 200 as well as various data temporarily or permanently. The program includes one or more instructions for operation of the management apparatus 200.

### (3) Processing Section 230

The processing section 230 provides various functions of the management apparatus 200. The processing section 230 includes a reception processing section 231, an obtaining section 233, and a transmission processing section 235. Note that the processing section 230 may further include another constituent element than these constituent elements. That is, the processing section 230 may perform operations other than the operations of these constituent elements. Specific operations of the reception processing section 231, the obtaining section 233, and the transmission processing section 235 will be described later in detail.

### (4) Implementation Example

The communication section 210 may be implemented with a transmission circuit and a reception circuit, a network adapter and/or a network interface card, etc. The storage section 220 may be implemented with memory (for example, non-volatile memory and/or volatile memory), and/or a hard disk, etc. The reception processing section 231, the obtaining section 233, and the transmission processing section 235 may be implemented by the same processor or implemented by respective different processors. The memory (the storage section 220) may be included in such a processor (chip).

The management apparatus 200 may include memory that stores programs (instructions) and one or more processors that are capable of executing the programs (instructions). The one or more processors may execute the programs and perform operations of the processing section 230 (operations of the reception processing section 231, the obtaining section 233, and the transmission processing section 235). The programs may be programs for causing a processor to execute the operations of the processing section 230 (operations of the reception processing section 231, the obtaining section 233, and the transmission processing section 235).

### <4.3. Configuration of Network Function Virtualization Controller>

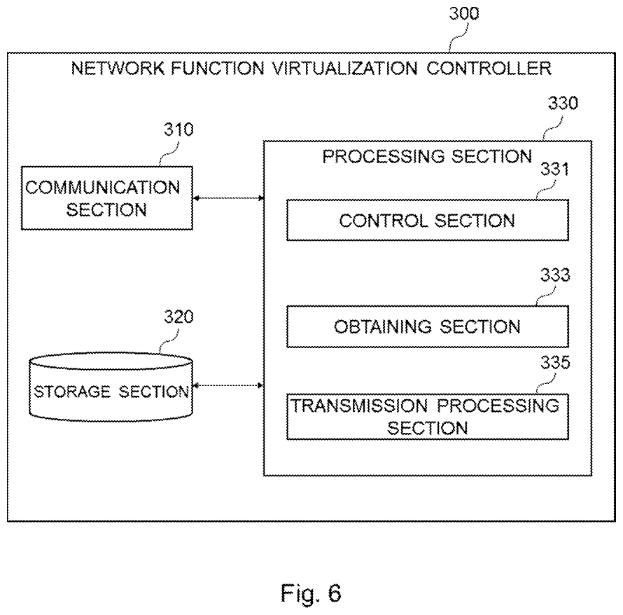

Next, with reference to FIG. 6, an example of a configuration of the network function virtualization controller 300 will be described. FIG. 6 is a block diagram illustrating an example of a schematic configuration of the network function virtualization controller 300. With reference to FIG. 6, the network function virtualization controller 300 includes a communication section 310, a storage section 320, and a processing section 330.

### (1) Communication Section 310

The communication section 310 receives respective signals from the hypervisor 21 and the management apparatus 200, and transmits respective signals to the hypervisor 21, the management apparatus 200, and other control apparatuses (such as the communication resource controller 100 and the application controller 400, for example).

### (2) Storage Section 320

The storage section 320 stores a program and parameters for operation of the network function virtualization controller 300 as well as various data temporarily or permanently. The program includes one or more instructions for operation of the network function virtualization controller 300.

### (3) Processing Section 330

The processing section 330 provides various functions of the network function virtualization controller 300. The processing section 330 includes a control section 331, an obtaining section 333, and a transmission processing section 335. Note that the processing section 330 may further include another constituent element than these constituent elements. That is, the processing section 330 may perform operations other than the operations of these constituent elements. Specific operations of the control section 331, the obtaining section 333, and the transmission processing section 335 will be described later in detail.

### (4) Implementation Example

The communication section 310 may be implemented with a transmission circuit and a reception circuit, a network adapter and/or a network interface card, etc. The storage section 320 may be implemented with memory (for example, non-volatile memory and/or volatile memory), and/or a hard disk, etc. The control section 331, the obtaining section 333, and the transmission processing section 335 may be implemented by the same processor or implemented by respective different processors. The memory (the storage section 320) may be included in such a processor (chip).

The network function virtualization controller 300 may include memory that stores programs (instructions) and one or more processors that are capable of executing the programs (instructions). The one or more processors may execute the programs and perform operations of the processing section 330 (operations of the control section 331, the obtaining section 333, and the transmission processing section 335). The programs may be programs for causing a processor to execute the operations of the processing section 330 (operations of the control section 331, the obtaining section 333, and the transmission processing section 335).

### <4.4. Configuration of Application Controller>

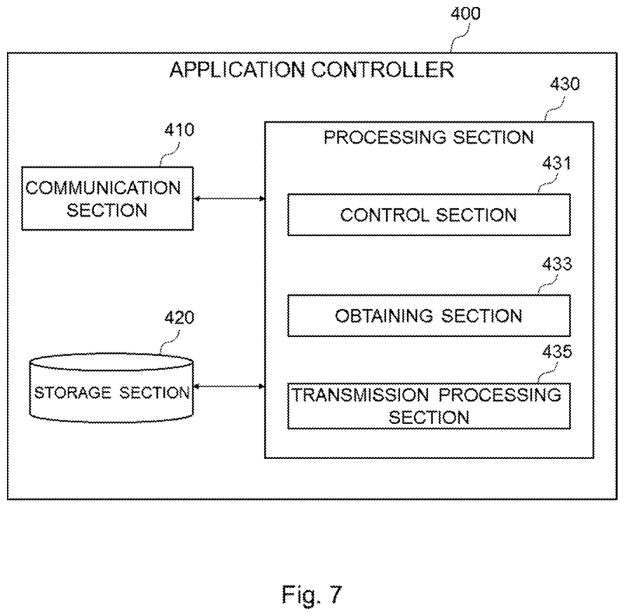

Next, with reference to FIG. 7, an example of a configuration of the application controller 400 will be described. FIG. 7 is a block diagram illustrating an example of a schematic configuration of the application controller 400. With reference to FIG. 7, the application controller 400 includes a communication section 410, a storage section 420, and a processing section 430.

### (1) Communication Section 410

The communication section 410 receives respective signals from the hypervisor 31 and the management apparatus 200, and transmits respective signals to the hypervisor 31, the management apparatus 200, and other control apparatuses (such as the communication resource controller 100 and the network function virtualization controller 300, for example).

### (2) Storage Section 420

The storage section 420 stores a program and parameters for operation of the application controller 400 as well as various data temporarily or permanently. The program includes one or more instructions for operation of the application controller 400.

### (3) Processing Section 430

The processing section 430 provides various functions of the application controller 400. The processing section 430 includes a control section 431, an obtaining section 433, and a transmission processing section 435. Note that the processing section 430 may further include another constituent element than these constituent elements. That is, the processing section 430 may perform operations other than the operations of these constituent elements. Specific operations of the control section 431, the obtaining section 433, and the transmission processing section 435 will be described later in detail.

### (4) Implementation Example

The communication section 410 may be implemented with a transmission circuit and a reception circuit, a network adapter and/or a network interface card, etc. The storage section 420 may be implemented with memory (for example, non-volatile memory and/or volatile memory), and/or a hard disk, etc. The control section 431, the obtaining section 433, and the transmission processing section 435 may be implemented by the same processor or implemented by respective different processors. The memory (the storage section 420) may be included in such a processor (chip).

The application controller 400 may include memory that stores programs (instructions) and one or more processors that are capable of executing the programs (instructions). The one or more processors may execute the programs and perform operations of the processing section 430 (operations of the control section 431, the obtaining section 433, and the transmission processing section 435). The programs may be programs for causing a processor to execute the operations of the processing section 430 (operations of the control section 431, the obtaining section 433, and the transmission processing section 435).

### <4.5. Technical Feature>

Next, technical features of the first example embodiment will be described.

The communication resource controller 100 (the reception processing section 133) receives time information related to time required for control of resource for providing service via the communication network 20. The control is performed by one or more other control apparatuses (such as the network function virtualization controller 300 and/or the application controller 400). Next, the communication resource controller 100 (the prediction section 135) predicts quality related to the service over a period based on the time information.

In addition, the management apparatus 200 (obtaining section 233) obtains time information related to time required for control of resource for providing service via the communication network 20. Next, the management apparatus 200 (the transmission processing section 235) transmits the time information to the communication resource controller 100 that predicts the quality related to the service.

In particular, the communication network 20 includes a wireless communication network. In addition, the wireless communication network includes a radio access network and a core network. In addition, specifically, the service is service provided to the UE 10 via the communication network 20.

### (1) Control of Resource

The resource includes calculation resource for providing the service.

### Calculation Resource

The calculation resource includes calculation resource of a virtual network function for providing the service. For example, the calculation resource of the virtual network function is controlled by the network function virtualization controller 300 (the control section 331).

The network function virtualization controller 300 (the obtaining section 333) obtains time information related to time required for control (second control) of calculation resource of the virtual network function, and the network function virtualization controller 300 (the transmission processing section 335) transmits the time information to the management apparatus 200. Next, the management apparatus 200 (the transmission processing section 235) transmits the time information to the communication resource controller 100.

In addition, the calculation resource includes calculation resource of the application for providing the service. For example, the calculation resource of the application is controlled by the application controller 400 (the control section 431).

The application controller 400 (the obtaining section 433) obtains time information related to time required for control (third control) of calculation resource of the application, and the application controller 400 (the transmission processing section 435) transmits the time information to the management apparatus 200. Next, the management apparatus 200 (the transmission processing section 235) transmits the time information to the communication resource controller 100.

In addition, the calculation resource is a virtual machine for providing the service. Specifically, examples of control of the virtual machine include allocation of processing capacity and memory capacity of a virtual machine that achieves the virtual network function, for example. The capacity is allocated by the network function virtualization controller 300 (the control section 331). In addition, the examples of control of the virtual machine include allocation of processing capacity and memory capacity of a virtual machine that implements the application server. The capacity is allocated by the application controller 400 (the control section 431).

Control of the calculation resource includes addition of the calculation resource and change of the calculation resource. For example, the network function virtualization controller 300 (the control section 331) adds and changes the virtual machine that achieves the virtual network function.

In addition, the change of the calculation resource may be change from calculation resource in a first base point to calculation resource in a second base point. For example, (the control section 431) of the application controller 400 changes calculation resource (virtual machine) that implements the application server, from calculation resource (virtual machine) in the first base point to calculation resource (virtual machine) in the second base point.

For example, with reference to the system configuration illustrated FIG. 1 as a specific example, change from calculation resource of the data center 1501 to calculation resource of the data center 1502 corresponds to change from the calculation resource in the first base point to the calculation resource in the second base point.

Note that, the time required for control of calculation resource of the application is not limited to execution time from a start to an end of the control. For example, the time required for control of calculation resource of the application includes waiting time before starting the control.

### Specific Example in Which There are Plurality of Pieces of Time Information

### (Specific Example 1)

For example, the time information received by the communication resource controller 100 includes time information related to time required for the second control and time information related to time required for the third control.

For example, the communication resource controller 100 receives the time information related to time required for the second control and the time information related to time required for the third control, from the management apparatus 200 that communicates with the network function virtualization controller 300 and the application controller 400.

The time information related to time required for the second control is time information required for the network function virtualization controller 300 to control calculation resource. More specifically, for example, the time information related to time required for the second control is time information required to add a virtual machine such as the number of virtual machines to be added, various parameters (the number of virtual processors and an amount of virtual memory) that characterize performance of the virtual machines to be added, or the like.

For example, the network function virtualization controller 300 (the obtaining section 333) obtains the time information related to time required for the second control by preliminarily recording actual execution time required for the second control and statistically estimating the time from the recorded data of the execution time. Alternatively, the network function virtualization controller 300 (the obtaining section 333) may obtain the time information related to time required for the second control by generating a workflow required for the second control, extracting a critical path in the workflow, and calculating the sum of time required in respective steps in the critical path.

The obtained time information related to time required for the second control is transmitted to the communication resource controller 100 by the network function virtualization controller 300 (the transmission processing section 335), and is received by the communication resource controller 100 (the reception processing section 133).

In addition, the time information related to time required for the third control is time information required for the application controller 400 to control calculation resource, for example. More specifically, for example, the time information related to time required for the third control is time information required to change calculation resource (virtual machine) for executing the application from the calculation resource (virtual machine) in the first base point to the calculation resource (virtual machine) in the second base point.

In a way similar to the time information related to time required for the second control, the application controller 400 (the obtaining section 433) obtains the time information related to time required for the third control by statistically estimating the time or calculating the sum of time required in respective steps in a critical path.

The obtained time information related to time required for the third control is transmitted to the communication resource controller 100 by the application controller 400 (the transmission processing section 435), and is received by the communication resource controller 100 (the reception processing section 133).

Note that, the communication resource controller 100 may receive the time information related to time required for the second control and the time information related to time required for the third control, from the management apparatus 200 that communicates with the network function virtualization controller 300 and the application controller 400.

### (Specific Example 2)

The time information received by the communication resource controller 100 is information generated on the basis of the time information related to time required for the second control and the time information related to time required for the third control.

For example, the time information is information generated by the management apparatus 200 on the basis of the time information related to time required for the second control and the time information related to time required for the third control.

First, the management apparatus 200 (the reception processing section 231) receives the time information related to time required for the second control from the network function virtualization controller 300, and receives the time information related to time required for the third control from the application controller 400.

Next, the management apparatus 200 (the obtaining section 233) generates time information related to time required to execute control procedure in which the second control and the third control are combined for maintaining the quality related to the service, on the basis of the time information related to time required for the second control and the time information related to time required for the third control. The management apparatus 200 (the transmission processing section 235) transmits the generated time information to the communication resource controller 100, and the communication resource controller 100 (the reception processing section 133) receives the transmitted time information.

### (2) Period Based on Time Information

### Calculation of Period

The period based on the time information includes the time required for the control of the resource and first time for the control of the resource.

For example, the period based on the time information is calculated by the communication resource controller 100 (the prediction section 135). Specifically, the communication resource controller 100 (the prediction section 135) calculates the sum of the time required for the control of the resource and the first time for the control of the resource, as the period based on the time information.

Here, for example, the first time is time taken before requesting the control of the resource. More specifically, for example, the first time is calculated from values such as time from when the communication resource controller 100 determines violation of the quality related to the service (to be described later) to when another control apparatus (such as the network function virtualization controller 300 or the application controller 400) is requested to control the resource, and delay time in communication between the communication resource controller 100 and the other control apparatus or the management apparatus 200.

### Update of Period

For example, when the other control apparatus (the network function virtualization controller 300 or the application controller 400) or the management apparatus 200 makes an update, the period based on the time information is updated.

First, the communication resource controller 100 (the reception processing section 133) receives the updated time information from the other control apparatus or the management apparatus 200.

Next, the communication resource controller 100 (the prediction section 135) updates the period based on the time information when the updated time information is received. The update of the period is new registration of a new period based on the time information.

### Others

Note that, the prediction section 135 may or may not calculate the period based on the time information. When the prediction section 135 does not calculate the period, a calculation section may be installed in the communication resource controller 100, for calculating the period based on the time information. Next, the prediction section 135 may be notified of the period calculated by the calculation section.

### (3) Quality Related to Service

### Prediction

For example, the communication resource controller 100 (the prediction section 135) uses history information of measured throughput and predicts quality related to the service over the period based on the time information. For example, the quality related to the service is throughput in a communication channel used for the service. More specifically, for example, the throughput is an amount of throughput of values per unit time in a gateway installed in the communication network 20.

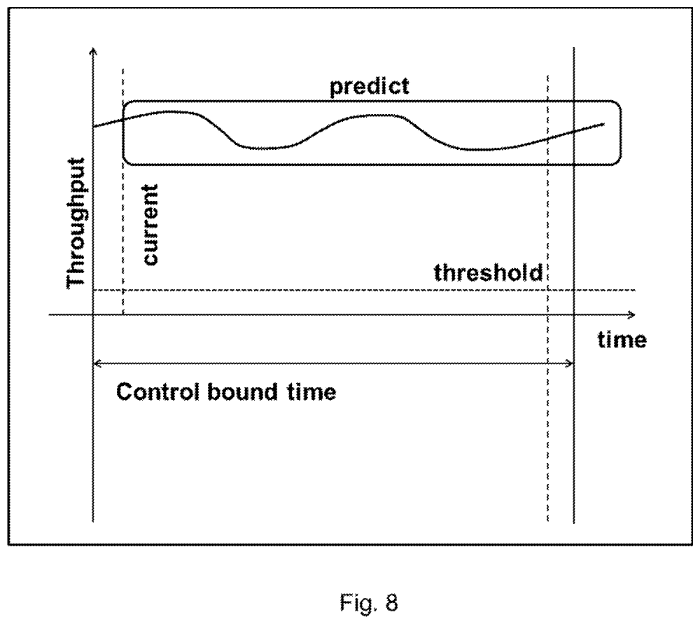

FIG. 8 is a diagram illustrating an example of predicted time response of throughput. Here, the period based on the time information corresponds to “Control bound time” illustrated in FIG. 8. In other words, the communication resource controller 100 (the prediction section 135) predicts throughput between a current time and “Control bound time”.

### Determination

The communication resource controller 100 (the determination section 137) determines whether the quality related the service becomes worse than a threshold during the period, on the basis of the predicted quality. Specifically, the communication resource controller 100 (the determination section 137) determines whether the predicted throughput becomes less than a threshold illustrated in FIG. 8.

### Request to Execute Control of Resource

The communication resource controller 100 (the request section 139) requests to execute the control of the resource when the quality related to the service becomes worse than the threshold during the period. Specifically, when it is determined that the throughput becomes less than the threshold at the “Control bound time” illustrated in FIG. 8, the communication resource controller 100 (the request section 139) requests to execute the control of the resource such as a request to add resource, for example.

For example, the communication resource controller 100 (the request section 139) requests another control apparatus (the network function virtualization controller 300 or the application controller 400) to execute the control of the resource. Alternatively, the communication resource controller 100 (the request section 139) requests the management apparatus 200 that communicates with another control apparatus (the network function virtualization controller 300 or the application controller 400) to execute the control of the resource. The communication resource controller 100 (the request section 139) may include information indicating a reason why the throughput becomes less than the threshold in its request when requesting to execute the control of the resource.

### (4) Flow of Process

### Process of Updating Period Based on Time Information

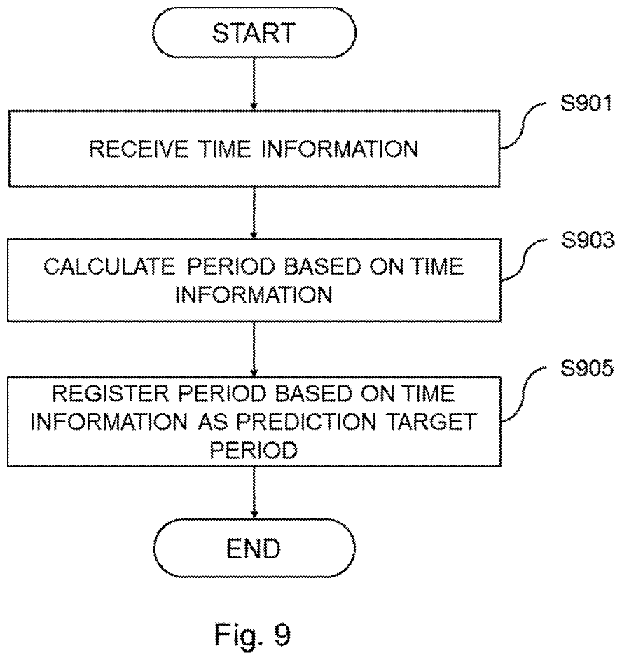

With reference to FIG. 9 to FIG. 11, an example of a process of updating a period based on time information will be described. FIG. 9 is a flowchart for describing an example of a schematic flow of a process of updating a period based on time information according to the first example embodiment.

First, in Step S901, the communication resource controller 100 (the reception processing section 133) receives updated time information, and proceeds to Step S903.

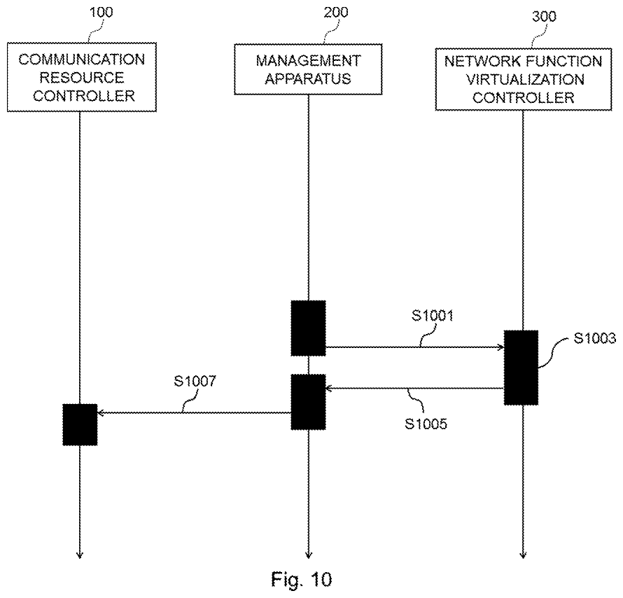

FIG. 10 is an explanatory diagram of an example of a schematic flow of a process of updating time information. For example, as illustrated in FIG. 10, the management apparatus 200 inquires of the network function virtualization controller 300 about time information (Step S1001). Next, the network function virtualization controller 300 obtains updated time information (Step S1003), and transmits the updated time information to the management apparatus 200 (Step S1005). Next, the management apparatus 200 transmits, to the communication resource controller 100, the time information received from the network function virtualization controller 300 (Step S1007).

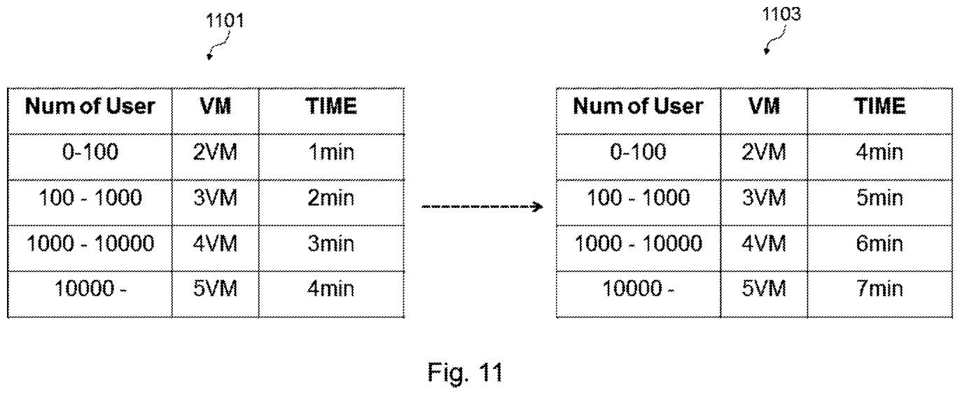

FIG. 11 is an explanatory diagram of respective examples of time information 1101 before update and time information 1103 after the update. The time information 1101 and the time information 1103 are information in which the number of users (Num of User) to whom the service is provided, the number of virtual machines (VM) to be added, and time (TIME) required to add the virtual machines (VM) are associated with each other. FIG. 11 illustrates an example in which the time information 1101 is updated to the time information 1103 and the time (TIME) required to add the virtual machines (VM) becomes longer.

In Step S903, the communication resource controller 100 (the prediction section 135) calculates time based on the time information received in Step S901, and proceeds to Step S905.

Next, in Step S905, the communication resource controller 100 (the prediction section 135) registers the period based on the time information as a throughput prediction target period, and the process illustrated in FIG. 9 ends.

### Process for Maintaining Quality Related to Service

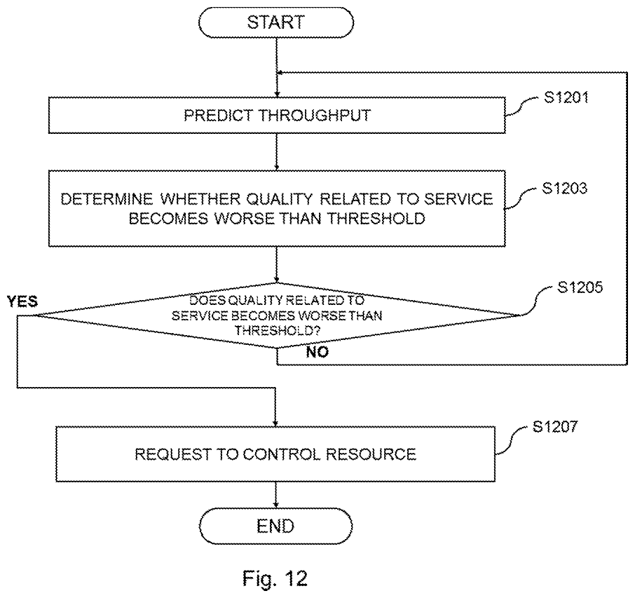

With reference to FIG. 12 to FIG. 14, an example of a process for maintaining quality related to service will be described. FIG. 12 is a flowchart for describing an example of a schematic flow of a process of maintaining quality related to service according to the first example embodiment.

First, in Step S1201, the communication resource controller 100 (the prediction section 135) predicts throughput during a period based on time information, and proceeds to Step S1203.

In Step S1203, the communication resource controller 100 (the determination section 137) determines whether the quality related to the service becomes worse than a threshold on the basis of the predicted throughput. For example, as illustrated in the example in FIG. 8, the communication resource controller 100 (the determination section 137) determines whether the predicted throughput becomes less than the threshold, and proceeds to Step S1205.

In Step S1205, the communication resource controller 100 proceeds to Step S1207 when the quality related to the service becomes worse than the threshold (YES in Step S1205). Alternatively, the communication resource controller 100 returns to Step S1201 and predicts throughput when the quality related to the service does not become worse than the threshold. (NO in Step S1205).

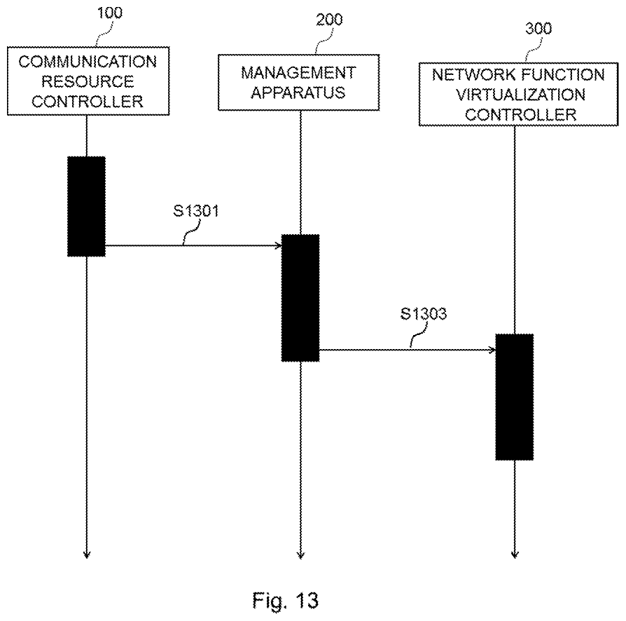

In Step S1207, for example, the communication resource controller 100 (the request section 139) requests the network function virtualization controller 300 to control the resource via the management apparatus 200 in accordance with the flow illustrated in FIG. 13, and the process illustrated in FIG. 12 ends.

FIG. 13 is an explanatory diagram of an example of a schematic flow of a process of requesting control of resource. As illustrated in FIG. 13, the communication resource controller 100 requests the management apparatus 200 to control the resource (Step S1301). Next, on the basis of the request from the communication resource controller 100, the management apparatus 200 requests the network function virtualization controller 300 to execute control of the resource such as a specific number of virtual machines to be added (Step S1303).

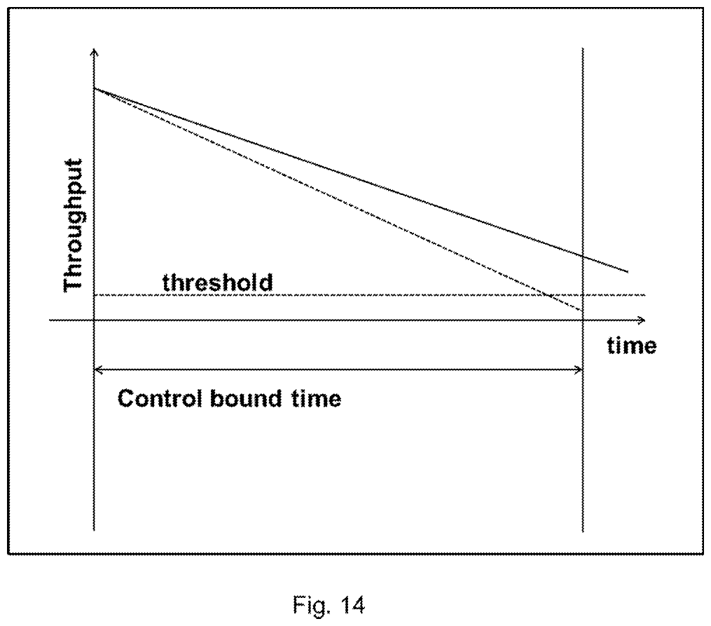

FIG. 14 is a diagram illustrating an example (dotted line) of predicted time response of throughput and an example (solid line) of time response of throughput when control of resource is executed.

As is clear from the example illustrated in FIG. 14, the predicted throughput may be lower than the threshold. On the basis of such a prediction result, the communication resource controller 100 is capable of requesting to control the resource before the throughput actually becomes lower than the threshold. Specifically, for example, the communication resource controller 100 may request to execute the control of the resource at a timing obtained by looking back time required for one or more other control apparatuses to perform control from a timing at which the predicted throughput is less than the threshold, or a timing earlier than that. As described above, it is possible to prevent the throughput from becoming less than the threshold by requesting to control the resource as described above.

In other words, the communication resource controller 100 is capable of accurately determining whether the quality becomes worse than the threshold on the basis of both a time information changing situation and change in QoS achievement situations of respective UEs based on the predicted throughput. Therefore, such determination enables the communication resource controller 100 to request another control apparatus to add minimum resource at an optimum timing in a manner that the respective UEs do not fail to achieve the QoS.

### (5) Example Alternations

### First Example Alternation

It is also possible for the communication resource controller 100 to inquire of the management apparatus 200 about time information more than once, obtain the time information, and make a determination related to quality related to service on the basis of a period calculated on the basis of a statistically convergent value of the obtained time information.

### Second Example Alternation

Alternatively, it is also possible for the management apparatus 200 to inquire of the communication resource controller 100 about an amount of resource that is necessary for maintaining quality related to service more than once, and calculate a convergent value of the calculation resource on the basis of results of the inquiries.

### Third Example Alternation

Alternatively, the present disclosure is not limited to the case where the time information is received from the management apparatus 200. It is also possible for the communication resource controller 100 to directly receive the time information from another control apparatus (such as the network function virtualization controller 300 and/or the application controller 400).

Specifically, the communication resource controller 100 (the reception processing section 131) may receive the time information from the network function virtualization controller 300. The time information is related to time required for the network function virtualization controller 300 (the control section 331) to control the resource. In addition, the communication resource controller 100 (the reception processing section 131) may receive time information from the application controller 400. The time information is related to time required for the application controller 400 (the control section 431) to control the resource.

### Fourth Example Alternation

Alternatively, the control of the resource may include communication resource for providing the service. For example, the communication resource is communication resource in the wireless communication network. More specifically, the communication resource includes at least one of communication resource of the radio access network and communication resource of the core network. For example, the control of the communication resource is control of a bearer or a band allocated to the UE 10, and the control of the communication resource is performed by the communication resource controller 100 (the control section 131). In addition, for example, the time information required for the control of the communication resource is transmitted to the network function virtualization controller 300 and/the application controller 400.

Next, the network function virtualization controller 300 may predict the quality related to the service on the basis of the received time information required for the control of the communication resource. In addition, the application controller 400 may also predict the quality related to the service on the basis of the received time information required for the control of the communication resource.

### (6) Conclusion

The first example embodiment has been described above. According to the first example embodiment, it will be possible to certainly maintain quality related to service while efficiently using resource for providing the service via a communication network, for example.

### 5. Second Example Embodiment

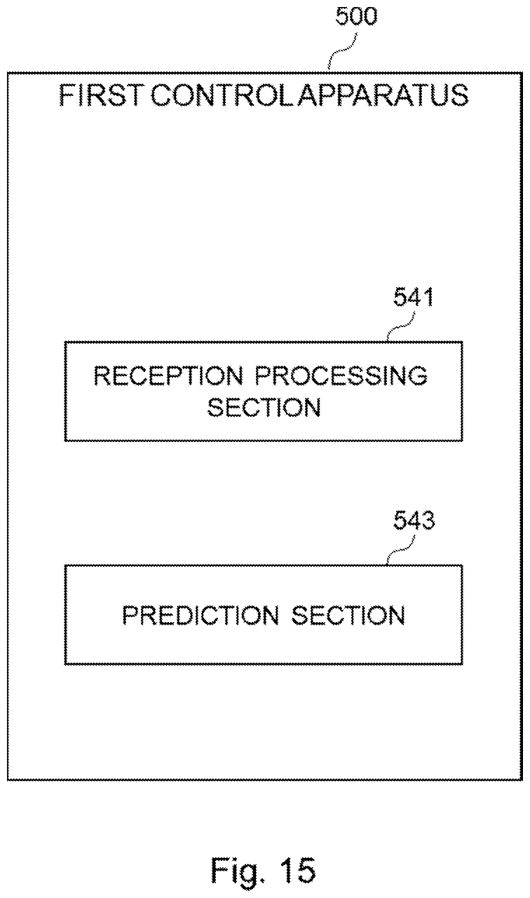

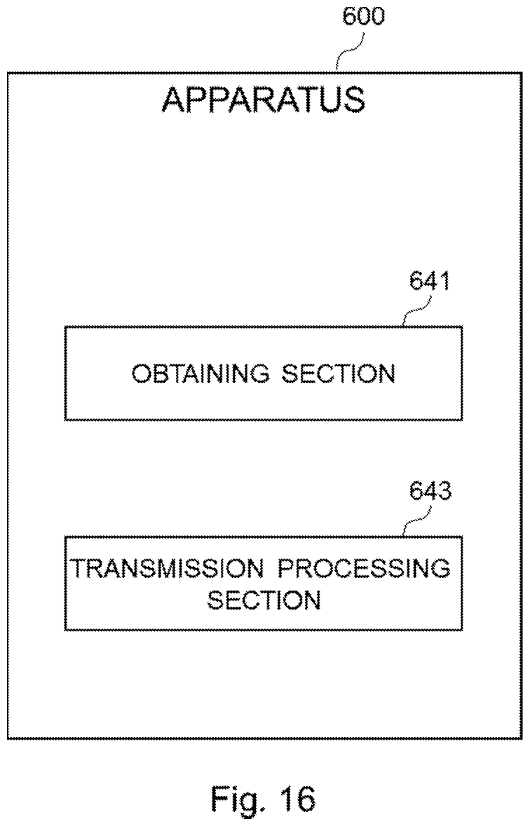

Next, the second example embodiment of the present invention will be described with reference to FIG. 15 and FIG. 16. The above-described first example embodiment is a specific example embodiment, whereas the second example embodiment is a more generalized example embodiment.

### <5.1. Configuration of First Control Apparatus>

First, with reference to FIG. 15, an example of a configuration of the first control apparatus 500 according to the second example embodiment will be described. FIG. 15 is a block diagram illustrating an example of a schematic configuration of the first control apparatus 500 according to the second example embodiment. With reference to FIG. 15, the first control apparatus 500 includes a reception processing section 541 and a prediction section 543. Specific operations of the reception processing section 541 and the prediction section 543 will be described later.

The reception processing section 541 and the prediction section 543 may be implemented by the same processor or implemented by respective different processors. The first control apparatus 500 may include memory that stores programs (instructions) and one or more processors that are capable of executing the programs (instructions). The one or more processors may execute the programs and perform operations of the reception processing section 541 and the prediction section 543. The programs may be programs for causing the processors to execute the operations of the reception processing section 541 and the prediction section 543.

### <5.2. Configuration of Apparatus>

First, with reference to FIG. 16, an example of a configuration of an apparatus 600 according to the second example embodiment will be described. FIG. 16 is a block diagram illustrating an example of a schematic configuration of the apparatus 600 according to the second example embodiment. With reference to FIG. 16, the apparatus 600 includes an obtaining section 641 and a transmission processing section 643. Specific operations of the obtaining section 641 and the transmission processing section 643 will be described later.

The obtaining section 641 and transmission processing section 643 may be implemented by the same processor or implemented by respective different processors. The apparatus 600 may include memory that stores programs (instructions) and one or more processors that are capable of executing the programs (instructions). The one or more processors may execute the programs and perform operations of the obtaining section 641 and the transmission processing section 643. The programs may be programs for causing the processors to execute the operations of the obtaining section 641 and the transmission processing section 643.

### <5.3. Technical Features>

Next, technical features of the second example embodiment will be described.

According to the second example embodiment, the first control apparatus 500 (the reception processing section 541) receives time information related to time required for control of resource for providing service via a communication network, the control being performed by one or more other control apparatuses. Next, the first control apparatus 500 (the prediction section 543) predicts quality related to the service over a period based on the time information.

For example, the first control apparatus 500 may be the communication resource controller 100 according to the first example embodiment described above. In other words, the reception processing section 541 may perform the operation of the reception processing section 133 according to the first example embodiment described above. In addition, the prediction section 543 may perform the operation of the prediction section 135 according to the first example embodiment described above. Note that, the operations of the first control apparatus 500 are not limited to the example of the operation of the communication resource controller 100.

On the other hand, the apparatus 600 (obtaining section 641) obtains time information related to time required for control of resource for providing service via the communication network. Next, the apparatus 600 (the transmission processing section 643) transmits the time information to the first control apparatus that predicts the quality related to the service.

For example, the apparatus 600 may be the management apparatus 200 according to the first example embodiment described above. In other words, the obtaining section 641 may perform the operation of the obtaining section 233 according to the first example embodiment described above. In addition, the transmission processing section 643 may perform the operation of the transmission processing section 235 according to the first example embodiment described above. Note that, the operations of the apparatus 600 are not limited to the example of the operation of the management apparatus 200.

The second example embodiment has been described above. According to the second example embodiment, it will be possible to certainly maintain quality related to service while efficiently using resource for providing the service via the communication network, for example.

### 6. Other Example Embodiments

Though example embodiments of the present invention have been described above, the present invention is not limited to these example embodiments. It will be understood by those of ordinary skill in the art that these example embodiments are illustrative only and that various alterations can be done without departing from the scope and spirit of the present invention.

For example, the steps in processes described in the present specification may not necessarily be performed chronologically in the order illustrated in the sequence diagrams. For example, steps in a process may be executed in a different order than the order illustrated in the sequence diagram or may be executed in parallel. Some of steps in the process may be removed or further steps may be added to the process.

In addition, it is also possible to provide an apparatus including the constituent elements (such as the control section, the reception processing section, the prediction section, the determination section, and/or the request section) of the communication resource controller described in the present specification (such as one or more apparatuses (or units) among multiple apparatuses (or units) constituting the communication resource controller, or a module for one of the multiple apparatuses (or units)). It is possible to provide an apparatus including the constituent elements (such as the reception processing section, the control section, the obtaining section, and/or the transmission processing section) of the management apparatus, the network function virtualization controller, or the application controller described in the present specification (such as a module for the management apparatus, the network function virtualization controller, or the application controller). In addition, methods including processes of such constituent elements may be provided, and programs for causing processors to execute processes of such constituent elements may be provided. Furthermore, computer-readable non-transitory recording medium having recorded thereon such programs may be provided. It is apparent that such apparatuses, modules, methods, programs, and computer-readable non-transitory recording media are also included in the present invention.

Some or all of the above-described example embodiments can be described as in the following Supplementary Notes, but are not limited to the following.

### (Supplementary Note 1)

A first control apparatus comprising:

a reception processing section configured to receive time information related to time required for control of resource for providing service via a communication network, the control being performed by one or more other control apparatuses; and

a prediction section configured to predict quality related to the service over a period based on the time information.

### (Supplementary Note 2)

The first control apparatus according to Supplementary Note 1, wherein the reception processing section is configured to receive the time information from the one or more other control apparatuses or a management apparatus which communicates with the one or more other control apparatuses.

### (Supplementary Note 3)

The first control apparatus according to Supplementary Note 1 or 2, further comprising a control section configured to perform first control of resource for providing a service via a communication network.

### (Supplementary Note 4)

The first control apparatus according to any one of Supplementary Notes 1 to 3, wherein

the one or more other control apparatuses include a second control apparatus and a third control apparatus; and

the control of the resource includes second control performed by the second control apparatus and third control performed by the third control apparatus.

### (Supplementary Note 5)

The first control apparatus according to Supplementary Note 4, wherein the time information includes time information related to time required for the second control and time information related to time required for the third control.

### (Supplementary Note 6)

The first control apparatus according to Supplementary Note 4, wherein the time information is information generated based on time information related to time required for the second control and time information related to time required for the third control.

### (Supplementary Note 7)

The first control apparatus according to any one of Supplementary Notes 1 to 6, wherein the period based on the time information includes the time required for the control of the resource and first time for the control of the resource.

### (Supplementary Note 8)

The first control apparatus according to Supplementary Note 7, wherein the first time is time taken before requesting the control of the resource.

### (Supplementary Note 9)

The first control apparatus according to any one of Supplementary Notes 1 to 8, wherein the reception processing section is configured to receive the time information when the time information is updated.

### (Supplementary Note 10)

The first control apparatus according to Supplementary Note 8, wherein the prediction section is configured to update the period based on the time information when the time information is received.

### (Supplementary Note 11)

The first control apparatus according to any one of Supplementary Notes 1 to 10, wherein the quality related to the service is throughput in a communication channel used for the service.

### (Supplementary Note 12)

The first control apparatus according to any one of Supplementary Notes 1 to 11, further comprising a determination section configured to determine whether the quality related the service becomes worse than a threshold during the period, on a basis of the predicted quality.

### (Supplementary Note 13)

The first control apparatus according to Supplementary Note 12, further comprising a request section configured to request execution of the control of the resource when the quality related to the service becomes worse than the threshold during the period.

### (Supplementary Note 14)

The first control apparatus according to Supplementary Note 13, wherein the request section requests the one or more other control apparatuses or the management apparatus which communicates with the one or more other control apparatuses, to execute the control of the resource.

### (Supplementary Note 15)

The first control apparatus according to any one of Supplementary Notes 1 to 14, wherein the resource includes calculation resource for providing the service.

### (Supplementary Note 16)

The first control apparatus according to Supplementary Note 15, wherein the calculation resource includes calculation resource of a virtual network function for providing the service.

### (Supplementary Note 17)

The first control apparatus according to Supplementary Note 15 or 16, wherein the calculation resource includes calculation resource of an application for providing the service.

### (Supplementary Note 18)

The first control apparatus according to any one of Supplementary Notes 15 to 17, wherein the calculation resource is a virtual machine for providing the service.

### (Supplementary Note 19)

The first control apparatus according to any one of Supplementary Notes 15 to 18, wherein the control includes addition of the calculation resource.

### (Supplementary Note 20)

The first control apparatus according to any one of Supplementary Notes 15 to 19, wherein the control includes change of the calculation resource.

### (Supplementary Note 21)

The first control apparatus according to Supplementary Note 20, wherein the change of the calculation resource is change from calculation resource in a first base point to calculation resource in a second base point.

### (Supplementary Note 22)

The first control apparatus according to any one of Supplementary Notes 1 to 8, wherein the resource includes communication resource for providing the service.

### (Supplementary Note 23)

The first control apparatus according to Supplementary Note 22, wherein

the communication network includes a wireless communication network, and

the communication resource is communication resource in the wireless communication network.

### (Supplementary Note 24)

The first control apparatus according to Supplementary Note 23, wherein

the wireless communication network includes a radio access network and a core network, and

the communication resource includes at least one of communication resource of the wireless communication network and communication resource of the core network.

### (Supplementary Note 25)

An apparatus comprising:

an obtaining section configured to obtain time information related to time required for control of resource for providing service via a communication network; and

a transmission processing section configured to transmit the time information to a first control apparatus that predicts quality related to the service.

### (Supplementary Note 26)

The apparatus according to Supplementary Note 25, wherein

the control of the resource is control performed by a second control apparatus, and

the apparatus is the second control apparatus.

### (Supplementary Note 27)

The apparatus according to Supplementary Note 25, wherein

the control of the resource is control performed by one or more other control apparatuses, and

the apparatus is a management apparatus which communicates with the one or more other control apparatuses.

### (Supplementary Note 28)

A method comprising:

receiving time information related to time required for control of resource for providing service via a communication network, the control being performed by one or more other control apparatuses; and

predicting quality related to the service over a period based on the time information.

### (Supplementary Note 29)

A method comprising:

obtaining time information related to time required for control of resource for providing service via a communication network; and

transmitting the time information to a first control apparatus that predicts quality related to the service.

### (Supplementary Note 30)

A program that causes a processor to:

receive time information related to time required for control of resource for providing service via a communication network, the control being performed by one or more other control apparatuses; and

predict quality related to the service over a period based on the time information.

### (Supplementary Note 31)

A program that causes a processor to:

obtain time information related to time required for control of resource for providing service via a communication network; and

transmit the time information to a first control apparatus that predicts quality related to the service.

### (Supplementary Note 32)

A computer-readable non-transitory recording medium having recorded thereon a program that causes a processor to:

receive time information related to time required for control of resource for providing service via a communication network, the control being performed by one or more other control apparatuses; and

predict quality related to the service over a period based on the time information.

### (Supplementary Note 33)

A computer-readable non-transitory recording medium having recorded thereon a program that causes a processor to:

obtain time information related to time required for control of resource for providing service via a communication network; and

transmit the time information to a first control apparatus that predicts quality related to the service.

### (Supplementary Note 34)

A system comprising:

a first control apparatus including
a reception processing section configured to receive time information related to time required for control of resource for providing service via a communication network, the control being performed by one or more other control apparatuses, and
a prediction section configured to predict quality related to the service over a period based on the time information; and

an apparatus including
an obtaining section configured to obtain the time information related to the time required for the control of the resource for providing the service via the communication network, and
a transmission processing section configured to transmit the time information to the first control apparatus that predicts the quality related to the service.

### INDUSTRIAL APPLICABILITY

It will be possible to certainly maintain quality related to service while efficiently using resource for providing the service via the communication network.

### REFERENCE SIGNS LIST

1 System
100 Communication Resource Controller
131, 331, 431 Control Section
133, 231, 541 Reception Processing Section
135, 543 Prediction Section
137 Determination Section
139 Request Section
200 Management Apparatus
233, 333, 433, 641 Obtaining Section
235, 335, 435, 643 Transmission Processing Section
300 Network Function Virtualization Controller
400 Application Controller
500 First Control Apparatus
600 Apparatus

1-34. (canceled)

35. A first control apparatus comprising:
a memory storing instructions; and
one or more processors configured to execute the instructions to
receive time information related to time required for control of resource for providing service via a communication network, the control being performed by one or more other control apparatuses; and
predict quality related to the service over a period based on the time information.

36. The first control apparatus according to claim 35, wherein the one or more processors are configured to execute the instructions to receive the time information from the one or more other control apparatuses or a management apparatus which communicates with the one or more other control apparatuses.

37. The first control apparatus according to claim 35, the one or more processors are further configured to execute the instructions to perform first control of resource for providing a service via a communication network.

38. The first control apparatus according to claim 35, wherein
the one or more other control apparatuses include a second control apparatus and a third control apparatus; and
the control of the resource includes second control performed by the second control apparatus and third control performed by the third control apparatus.

39. The first control apparatus according to claim 38, wherein the time information includes time information related to time required for the second control and time information related to time required for the third control.

40. The first control apparatus according to claim 38, wherein the time information is information generated based on time information related to time required for the second control and time information related to time required for the third control.

41. The first control apparatus according to claim 35, wherein the period based on the time information includes the time required for the control of the resource and first time for the control of the resource.

42. The first control apparatus according to claim 41, wherein the first time is time taken before requesting the control of the resource.

43. The first control apparatus according to claim 35, wherein the one or more processors are configured to execute the instructions to receive the time information when the time information is updated.

44. The first control apparatus according to claim 42, wherein the one or more processors are configured to execute the instructions to update the period based on the time information when the time information is received.

45. The first control apparatus according to claim 35, wherein the quality related to the service is throughput in a communication channel used for the service.

46. The first control apparatus according to claim 35, the one or more processors are further configured to execute the instructions to determine whether the quality related the service becomes worse than a threshold during the period, on a basis of the predicted quality.

47. The first control apparatus according to claim 46, the one or more processors are further configured to execute the instructions to request execution of the control of the resource when the quality related to the service becomes worse than the threshold during the period.

48. The first control apparatus according to claim 47, wherein the one or more processors are configured to execute the instructions to request the one or more other control apparatuses or the management apparatus which communicates with the one or more other control apparatuses, to execute the control of the resource.

49. The first control apparatus according to claim 35, wherein the resource includes calculation resource for providing the service.

50. The first control apparatus according to claim 49, wherein the calculation resource includes calculation resource of a virtual network function for providing the service.

51. The first control apparatus according to claim 49, wherein the calculation resource includes calculation resource of an application for providing the service.

52. The first control apparatus according to claim 49, wherein the calculation resource is a virtual machine for providing the service.

53. The first control apparatus according to claim 49, wherein the control includes addition of the calculation resource.

54. The first control apparatus according to claim 49, wherein the control includes change of the calculation resource.

55. The first control apparatus according to claim 54, wherein the change of the calculation resource is change from calculation resource in a first base point to calculation resource in a second base point.

56. The first control apparatus according to claim 35, wherein the resource includes communication resource for providing the service.

57. The first control apparatus according to claim 56, wherein
the communication network includes a wireless communication network, and
the communication resource is communication resource in the wireless communication network.

58. The first control apparatus according to claim 57, wherein
the wireless communication network includes a radio access network and a core network, and
the communication resource includes at least one of communication resource of the radio access network and communication resource of the core network.

59. An apparatus comprising:
a memory storing instructions; and
one or more processors configured to execute the instructions to
obtain time information related to time required for control of resource for providing service via a communication network; and
transmit the time information to a first control apparatus that predicts quality related to the service.

60. The apparatus according to claim 59, wherein
the control of the resource is control performed by a second control apparatus, and
the apparatus is the second control apparatus.

61. The apparatus according to claim 59, wherein
the control of the resource is control performed by one or more other control apparatuses, and
the apparatus is a management apparatus which communicates with the one or more other control apparatuses.

62. A method comprising:
receiving time information related to time required for control of resource for providing service via a communication network, the control being performed by one or more other control apparatuses; and
predicting quality related to the service over a period based on the time information.

63. A method comprising:
obtaining time information related to time required for control of resource for providing service via a communication network; and
transmitting the time information to a first control apparatus that predicts quality related to the service.

64. A computer-readable non-transitory recording medium having recorded thereon a program that causes a processor to:
receive time information related to time required for control of resource for providing service via a communication network, the control being performed by one or more other control apparatuses; and
predict quality related to the service over a period based on the time information.

65. A computer-readable non-transitory recording medium having recorded thereon a program that causes a processor to:
obtain time information related to time required for control of resource for providing service via a communication network; and
transmit the time information to a first control apparatus that predicts quality related to the service.

66. A system comprising:
a first control apparatus including
a memory storing instructions; and
one or more processors configured to execute the instructions to
receive time information related to time required for control of resource for providing service via a communication network, the control being performed by one or more other control apparatuses, and
predict quality related to the service over a period based on the time information; and
an apparatus including
a memory storing instructions; and
one or more processors configured to execute the instructions to
obtain the time information related to the time required for the control of the resource for providing the service via the communication network, and
transmit the time information to the first control apparatus that predicts the quality related to the service.
